(19) United States
(12) Patent Application Publication
(10) Pub. No.: US 2026/0089782 A1
(43) Pub. Date: Mar. 26, 2026

(54) Piggybacking Wi-Fi Information on a Bluetooth Communication

(71) Applicant: Apple Inc., Cupertino, CA (US)

(72) Inventors: Imran Latif, Pleasanton, CA (US); Yilok L. Wong, San Diego, CA (US)

(21) Appl. No.: 19/321,033

(22) Filed: Sep. 5, 2025

Related U.S. Application Data
(60) Provisional application No. 63/697,410, filed on Sep. 20, 2024.

(51) Int. Cl. H04W 76/15; H04W 76/14; H04W 84/12

(52) U.S. Cl. CPC H04W 76/15; H04W 76/14; H04W 84/12

(57) ABSTRACT

A method of establishing a Wi-Fi connection at a first wireless device using Bluetooth is disclosed. The method comprises establishing a Bluetooth connection between a first wireless device and one or more other wireless devices. Wi-Fi connection information is sent from the first wireless device to the one or more other wireless devices via the Bluetooth connection. A Wi-Fi connection is established between the first wireless device and the one or more other wireless devices using the Wi-Fi connection information. The first wireless device and the one or more other wireless devices communicate using the Wi-Fi connection.

### PRIORITY

This application claims the benefit of U.S. Provisional Patent Application Ser. No. 63/697,410, filed on Sep. 20, 2024, which is incorporated herein by reference.

### FIELD

Embodiments relate to wireless communications, including apparatuses, systems, and methods for piggybacking Wi-Fi information on a Bluetooth communication.

### DESCRIPTION OF THE RELATED ART

Wireless communication in local area networks (LANs) and personal area networks (PANs) is commonly conducted using shared radio frequency (RF) bands, such as industrial, scientific, and medical (ISM) bands. The ubiquitous use of the publicly available ISM bands leads to the significant potential for congestion and interference. The use of other RF devices, such as microwave ovens, which also operate within an ISM band, can create broadband interference at relatively high power levels. This can affect the performance of real-time or near real-time communication using devices that communicate in the ISM bands, which can negatively impact user experience.

### BRIEF DESCRIPTION OF THE DRAWINGS

A better understanding of the present subject matter can be obtained when the following detailed description of various embodiments is considered in conjunction with the following drawings.

FIG. 1A illustrates an example wireless communication system including wireless devices configured to communicate via peer to peer communication over multiple radio access technologies (RATs), according to some embodiments.

FIG. 1B illustrates an example illustration of a multi-RAT wireless device that communicates using Bluetooth and Wi-Fi, according to some embodiments.

FIG. 1C provides an example illustration in which a Wi-Fi host can communicate with a Bluetooth host, according to some embodiments.

FIG. 2 illustrates an example block diagram of a wireless device, according to some embodiments.

FIG. 3 illustrates an example block diagram of a wireless device configured to communicate according to multiple radio access technologies (RATs), according to some embodiments.

FIG. 4 illustrates an example simplified block diagram of wireless communication circuitry, according to some embodiments.

FIG. 5A illustrates an example diagram of a Bluetooth low energy (BLE) frequency band with 40 channels each having a 2 Megahertz (MHz) bandwidth, according to some embodiments.

FIG. 5B illustrates an example of a Bluetooth low energy (BLE) protocol stack, according to some embodiments.

FIG. 6 illustrates an example of a communication between a primary wireless device and a secondary wireless device for Bluetooth BLE, according to some embodiments.

FIG. 7 illustrates an example of a synchronization of a Bluetooth transmitter and a Bluetooth receiver, according to some embodiments.

FIG. 8 illustrates an example of a time division duplex (TDD) transmission scheme with multi-slot packets and frequency hops f(k), according to some embodiments.

FIG. 9 illustrates an example illustration of a flow chart for adaptive frequency hopping, according to some embodiments.

FIG. 10 is an example of a BLE link layer protocol data unit (PDU), according to some embodiments.

FIG. 11A is an example of a Wi-Fi MAC header, according to some embodiments.

FIG. 11B is an example of an information element in a management frame, according to some embodiments.

FIG. 12 is an example of an IEEE 802 reference model relative to an OSI reference model, according to some embodiments.

FIG. 13 is an example illustration of a Bluetooth communication used to send Wi-Fi information between two or more wireless devices, according to some embodiments.

FIG. 14 is an example communication diagram between wireless devices, according to some embodiments.

FIG. 15 illustrates an example flow chart of a method of combining packet retransmission at a Bluetooth receiver, according to some embodiments.

FIG. 16 illustrates an example flow chart of a method of sending Wi-Fi information using Bluetooth, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium or Memory—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Bluetooth—a short-range wireless technology standard that is used for exchanging data between fixed and mobile devices. Bluetooth includes two different types of devices, typically referred to as Bluetooth Classic (BTC) and Bluetooth Low Energy (BLE). BTC comprises Bluetooth specification release 1.0 to 3.0. BLE comprises Bluetooth specification release 4.0 to 6.0.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of stations include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, and so forth. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile) or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” or “Access Point” has the full breadth of its ordinary meaning, and at least includes a wireless communication station installed at a fixed location and used to communicate with UEs as part of a wireless communication system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

IEEE 802.11—refers to technology based on the Institute of Electronics and Electrical Engineers (IEEE) 802.11 wireless standards such as 802.11a, 802.11.b, 802.11g, 802.11n (Wi-Fi 4), 802.11-2012, 802.11ac (Wi-Fi 5), 802.11ad, 802.11ax (Wi-Fi 6 and 6E), 802.11ay, 802.11be (Wi-Fi 7), 802.11bn (Wi-Fi 8) and/or other IEEE 802.11 standards. IEEE 802.11 technology may also be referred to as “Wi-Fi” or “wireless local area network (WLAN)” technology.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, 3GPP LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, such as Wi-Fi, WLAN channels may be 22 MHz wide, while Bluetooth channels may be 79 channels that are 1 MHz wide for a BTC system or 40 channels that are 2 MHz wide for BLE systems. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

The example embodiments may be further understood with reference to the following description and the related appended drawings, wherein like elements are provided with the same reference numerals. The example embodiments relate to apparatuses, systems and methods for reducing energy usage by network components, e.g., base stations in wireless communication systems.

The example embodiments are described with regard to communication between a wireless devices configured to communicate according to a Bluetooth specification. However, reference to wireless device, primary wireless device, secondary wireless device, Bluetooth receiver, or Bluetooth transmitter is merely provided for illustrative purposes. The example embodiments may be utilized with any electronic component that may establish a connection between wireless devices that are configured with the hardware, software, and/or firmware to support wireless communication in short distances, such as less than 10 meters or less than 100 meters. Therefore, the wireless devices as described herein is used to represent any appropriate type of electronic component.

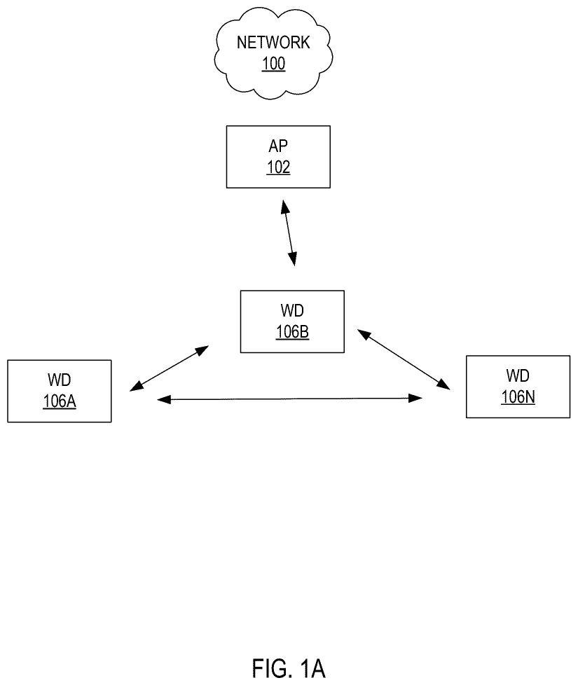

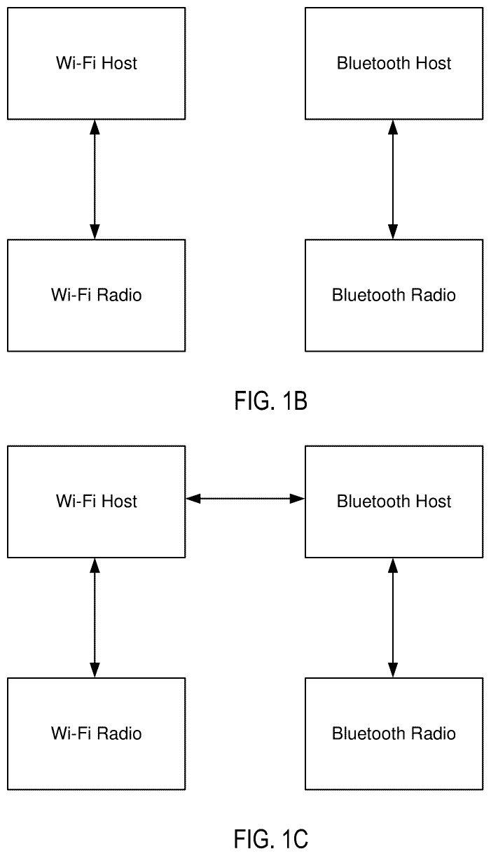

### FIGS. 1A, 1B: Wireless Communication Systems

FIG. 1A illustrates a simplified example of a wireless communication system including wireless devices configured to communicate via peer to peer communication, such as Apple Wireless Direct Link, over multiple radio access technologies (RATs). It is noted that the system of FIG. 1A is merely one example of a possible system, and that features of this disclosure may be implemented in any of various systems, as desired.

As shown, the example wireless communication system includes a wireless device (WD) 106 which communicates over a transmission medium with one or more other wireless devices 106A, 106B . . . 106N. Each of the wireless devices may be configured to communicate using a Bluetooth communication protocol, including BTC and BLE, and a Wi-Fi protocol. A single wireless device is referred to as wireless device 106.

The wireless device 106 may be a device with wireless network connectivity such as a mobile phone, a hand-held device, a laptop, a wearable device, a computer or a tablet, an automobile, or virtually any type of wireless device. The wireless device 106 may include a processor (processing element) that is configured to execute program instructions stored in memory. The wireless device 106 may perform any of the method embodiments described herein by executing such stored instructions. Alternatively, or in addition, the wireless device 106 may include a programmable hardware element such as an FPGA (field-programmable gate array), programmable logic device (PLD), application specific integrated circuit (ASIC), an integrated circuit, and/or any of various other possible hardware components that are configured to perform (e.g., individually or in combination) any of the method embodiments described herein, or any portion of any of the method embodiments described herein.

The wireless devices 106A through N may communicate with a network 100 (e.g., a core network of a cellular service provider, a telecommunication network, such as a public switched telephone network (PSTN) or a fully digital phone network, and/or the Internet, among various possibilities). Thus, each wireless device may use the network 100 to communicate over longer distances or access the internet.

One or more of the wireless devices 106A through N can be configured to communicate over the transmission medium using a Bluetooth wireless technology standard. The Bluetooth wireless technology standard includes the release of the Bluetooth Core Specification Versions 1.0, 1.0B, 1.1, 1.2, 2.0, 2.1, or 3.0, which are commonly referred to as Bluetooth Classic (BTC), or Versions 4.0, 4.1, 4.2, 5, 5.1, 5.2, 5.3, 5.4, or 6.0, which are commonly referred to as Bluetooth Low Energy (BLE). In addition, one or more of the wireless devices 106A . . . N can be configured to communicate using an Institute of Electrical and Electronics Engineers (IEEE) 802.11 standard via a Local Area Network (LAN).

While the examples disclosed herein will focus on communication via Bluetooth and Wi-Fi, the wireless devices 106A through N can also include additional radio access technologies (RATs) for wide area network (WAN) communications, such as the third generation partnership project (3GPP). 3GPP standards include 4G, Long term evolution (LTE), LTE-Advanced (LTE-A), and 5G new radio (5G NR).

Wireless devices 106A-N operating according to one or more radio access technologies may thus be provided as a network of cells, which may provide continuous or nearly continuous overlapping service over a geographic area via one or more radio access technology.

The wireless devices 106A-N may include handheld devices such as smart phones or tablets, wearable devices such as smart watches or smart glasses, and/or may include any of various types of devices with cellular communications capability. For example, one or more of the wireless devices 106A-N may be a wireless device intended for stationary or nomadic deployment such as an appliance, measurement device, control device, etc.

Each wireless device 106A-N, which may be referred to singly as a wireless device 106, may include one or more devices or integrated circuits for facilitating wireless communication, potentially including a cellular modem and/or one or more other wireless modems. The wireless modem(s) may include one or more processors (processor elements), and various hardware components as described herein. The wireless device 106 may perform any of the method embodiments described herein by executing instructions on one or more programmable processors. Alternatively, or in addition, the one or more processors may be one or more programmable hardware elements such as an FPGA (field-programmable gate array), programmable logic device (PLD), application specific integrated circuit (ASIC), or other circuitry, which is configured to perform any of the method embodiments described herein, or any portion of any of the method embodiments described herein.

The wireless device 106 may include one or more antennas for communicating using one or more wireless communication protocols or radio access technologies. In some embodiments, the wireless device 106 might be configured to communicate using a single shared radio. The shared radio may couple to a single antenna, or may couple to multiple antennas (e.g., for MIMO) for performing wireless communications. Alternatively, the wireless device 106 may include two or more radios, each of which may be configured to communicate via a respective wireless link. Other configurations are also possible.

Wireless communications standards, such as Bluetooth and Wi-Fi, each have advantages and disadvantages. For instance, Bluetooth can provide low latency, low power communications. However, Bluetooth communications are relatively low bandwidth, with a typical peak transmission rate of between 1 and 3 megabits per second (MB/s). Wi-Fi communication can provide higher bandwidth communication of several gigabits per second (GB/s). The latency to setup a Wi-Fi link, such as a peer to peer link, or begin a new Wi-Fi communication can be relatively high compared with Bluetooth due to unique sensing performed by Wi-Fi radios to ensure that the medium is open and available for communication. In addition, congestion in crowded bands can also increase latency in Wi-Fi communications.

FIG. 1B provides an example illustration of a multi-RAT wireless device that communicates using Bluetooth and Wi-Fi. In a traditional device, a Wi-Fi host communicates directly with a Wi-Fi radio. Similarly, a Bluetooth host communicates with a Bluetooth radio. The two radios perform independently.

In accordance with some embodiments, FIG. 1C provides an example illustration in which the Wi-Fi host can communicate with the Bluetooth host. This enables the Wi-Fi host to send information, such as Wi-Fi control information or data, to the Bluetooth host. The Wi-Fi control information can then be communicated from a first wireless device, such as 106A in FIG. 1A, to one or more other wireless devices 106B . . . N. The Wi-Fi control information and/or data this received by the one or more other wireless devices 106B . . . N can then be used, for example, to setup and establish a Wi-Fi communication link between the first wireless device 106A and the one or more other wireless devices 106B . . . N. The ability to send Wi-Fi control information and/or data using a Bluetooth link can significantly reduce latency in setting up peer to peer communications, such as Apple Wireless Direct Link, between wireless devices 106A . . . N. In addition, the Bluetooth link may be used to send data on occasions where interference or congestion has slowed communication on a Wi-Fi link below a threshold level. The ability to use Bluetooth communications to improve latency in a peer to peer network, while using Wi-Fi communications to provide broadband communications, enables the two radio access technologies to work symbiotically, enabling low latency, broadband communication between wireless devices with an increase in quality of service (QoS) and other key performance indicators (KPI).

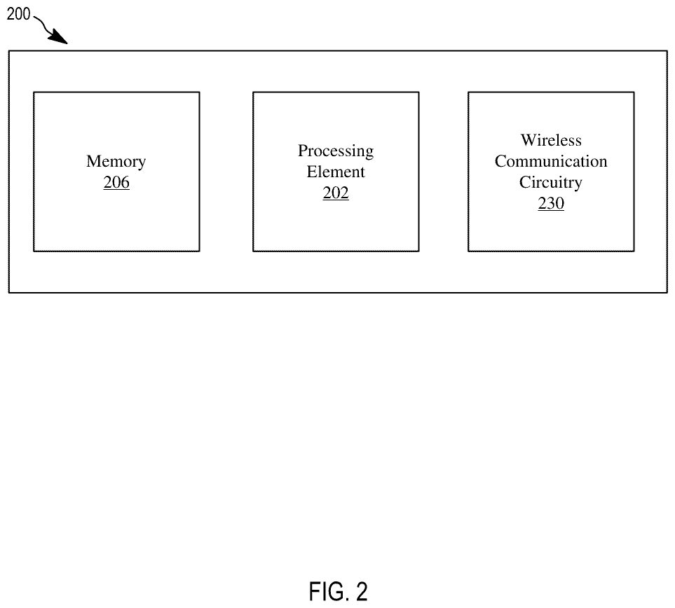

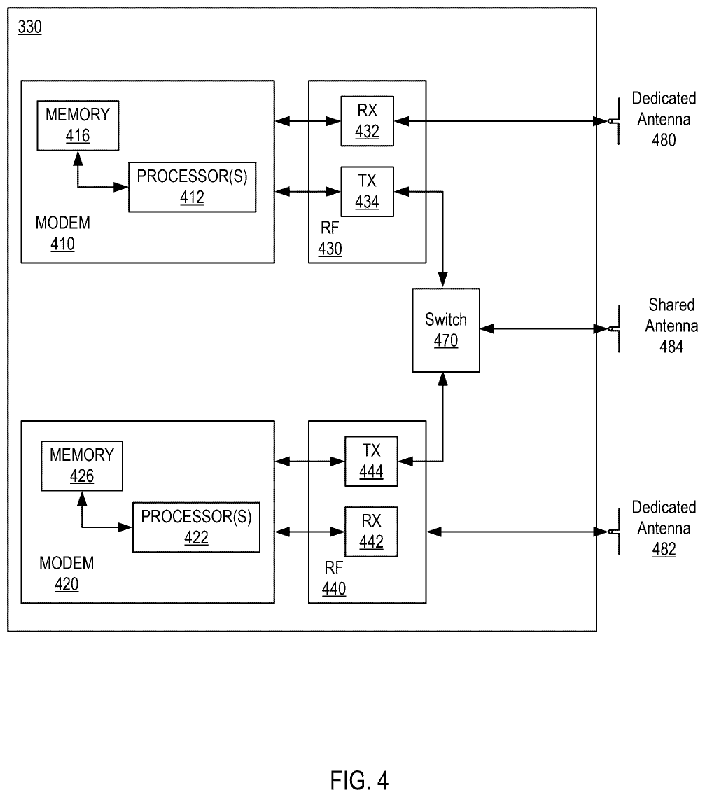

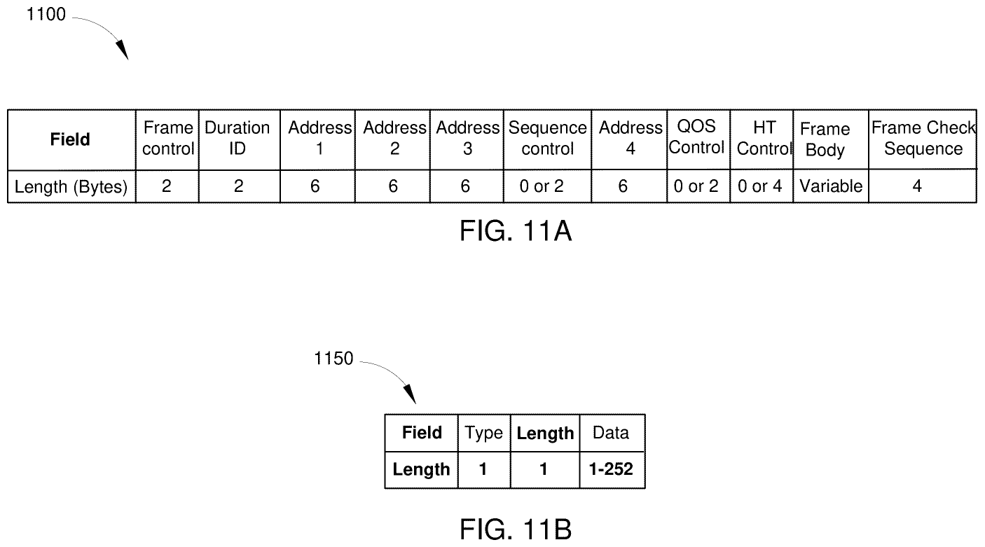

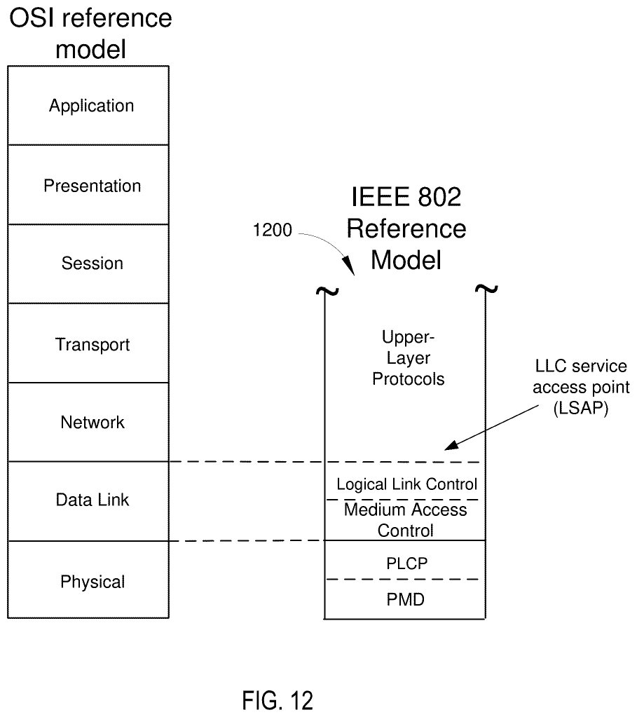

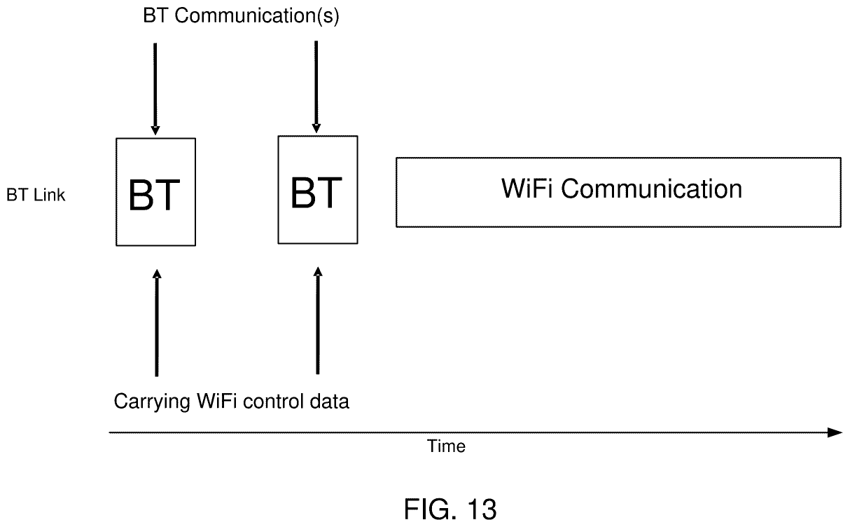

Embodiments for piggybacking Wi-Fi communication on a Bluetooth link will be more fully described in the proceeding paragraphs. FIGS. 2-4 provide example illustrations of wireless hardware devices. FIGS. 4-10 provide examples of Bluetooth operations. FIGS. 11-12 provide examples of Wi-Fi operations. FIGS. 13-16 provide example embodiments.

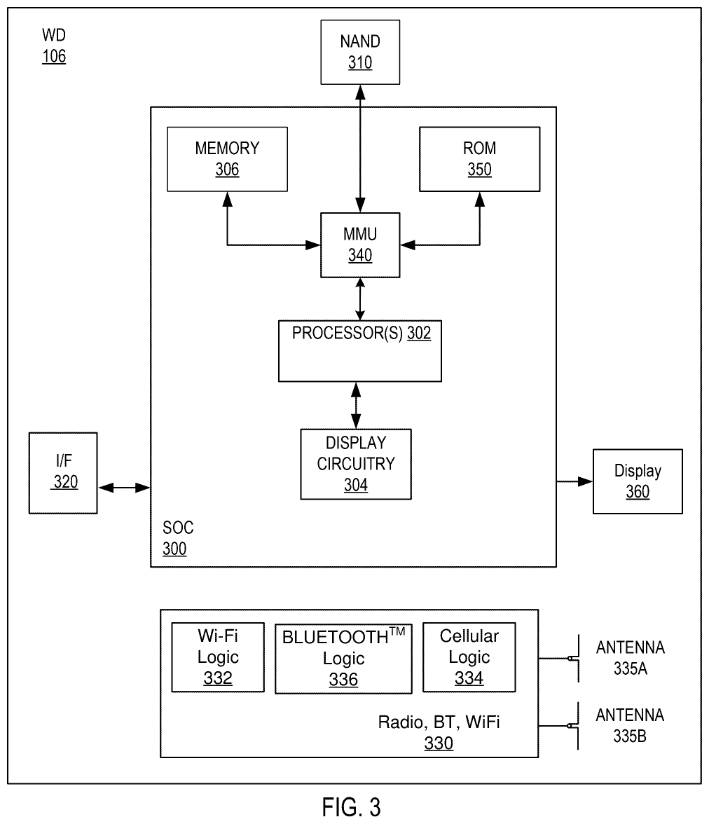

### FIG. 2-3: Block Diagrams of a Wireless Device

FIG. 2 illustrates an exemplary wireless device 200 that may be configured for use in conjunction with various aspects of the present disclosure. For example, the device 200 may be an example of one or more of the wireless devices 106A . . . N. The device 200 may be any of a variety of types of device and may be configured to perform any of a variety of types of functionality. The device 200 may be a substantially portable device or may be a substantially stationary device, potentially including any of a variety of types of device. The device 200 may be configured to perform one or more wireless communication coexistence techniques or features, such as any of the techniques or features illustrated and/or described subsequently herein with respect to any or all of FIGS. 4-16.

As shown, the device 200 may include a processing element 202. The processing element may include or be coupled to one or more memory elements. For example, the device 200 may include one or more memory media (e.g., memory 206), which may include any of a variety of types of memory and may serve any of a variety of functions. For example, memory 206 could be RAM serving as a system memory for processing element 202. Other types and functions are also possible.

Additionally, the device 200 may include wireless communication circuitry 230. The wireless communication circuitry may include any of a variety of communication elements (e.g., antenna for wireless communication, analog and/or digital communication circuitry/controllers, etc.) and may enable the device to wirelessly communicate using one or more wireless communication protocols.

Note that in some cases, the wireless communication circuitry 230 may include its own processing element (e.g., a baseband processor and/or control processor), e.g., in addition to the processing element 202. For example, the processing element 202 might be (or include) an ‘application processor’ whose function may include supporting application layer operations in the device 200, while the wireless communication circuitry 230 might include a ‘baseband processor’ (or functionally similar component(s)) whose function may include supporting baseband layer operations (e.g., to facilitate wireless communication between the device 200 and other wireless devices) in the device 200. In other words, in some cases the device 200 may include multiple processing elements (e.g., may be a multi-processor device). Other configurations (e.g., instead of or in addition to an application processor/baseband processor configuration) utilizing a multi-processor architecture are also possible.

The device 200 may include any of a variety of other components (not shown) for implementing device functionality, depending on the intended functionality of the device 200, which may include further processing and/or memory elements (e.g., audio processing circuitry), one or more power supply elements (which may rely on battery power and/or an external power source), user interface elements (e.g., display, speaker, microphone, camera, keyboard, mouse, touchscreen, etc.), sensors, and/or any of various other components.

The components of the device 200, such as processing element 202, memory 206, and wireless communication circuitry 230, may be operatively coupled via one or more interconnection interfaces, which may include any of a variety of types of interface, possibly including a combination of multiple types of interface. As one example, a universal serial bus (USB) high-speed inter-chip (HSIC) interface may be provided for inter-chip communications between processing elements. Alternatively (or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 202, peripheral interfaces for communication with peripheral components within or external to device 200, etc.) may also be provided as part of device 200.

FIG. 3 illustrates one possible block diagram of a wireless device, such as wireless device 106, configured to communicate according to multiple radio access technologies (RATs) including a Bluetooth specification, and a Wi-Fi specification. As shown, the wireless device 106 may include a system on chip (SOC) 300, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may be coupled to various other circuits of the wireless device 106. For example, the wireless device 106 may include various types of memory (e.g., including NAND flash memory 310), a connector interface 320 (e.g., for coupling to a computer system, dock, charging station, etc.), a display 360, and wireless communication circuitry 330 (e.g., for Bluetooth, Wi-Fi, LTE, LTE-A, NR, NFC, etc.).

As shown, the SOC 300 may include processor(s) 302 which may execute program instructions for the wireless device 106, and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310). The MMU 340 may be configured to perform memory protection and page table translation or set up. In some embodiments, the MMU 340 may be included as a portion of the processor(s) 302.

The wireless device 106 may include at least one antenna, and in some embodiments, multiple antennas 335A and 335B, for performing wireless communication with other wireless devices, access points, and/or base stations. For example, the wireless device 106 may use antennas 335A and 335B to perform the wireless communication. As noted above, the wireless device 106 may in some embodiments be configured to communicate wirelessly using a plurality of wireless communication standards or RATs.

The wireless communication circuitry 330 may include Bluetooth Logic 336, Wi-Fi Logic 332, and Cellular Logic 334. The Bluetooth Logic 336 is for enabling the wireless device 106 to perform Bluetooth communications. The Wi-Fi Logic 332 is for enabling the wireless device 106, operating as a STA, to perform Wi-Fi or other WLAN communications on an IEEE 802.11 network. The cellular Logic 334 may be a cellular modem capable of performing cellular communication according to one or more cellular communication technologies such as 3GPP.

In some embodiments, the wireless communication circuitry 330 may include its own processing element (e.g., a baseband processor and/or control processor), e.g., in addition to the processing element 202. For example, the processing element 202 may be (or include) an ‘application processor’ whose function may include supporting application layer operations in the wireless device 106, while the wireless communication circuitry 330 might include a ‘baseband processor’ (or functionally similar component(s)) whose function may include supporting baseband layer operations (e.g., to facilitate wireless communication between the wireless device 106A and other wireless devices 106B . . . N) in the wireless device 106A. In other words, in some cases the wireless device 106A may include multiple processing elements (e.g., may be a multi-processor device). Other configurations (e.g., instead of or in addition to an application processor/baseband processor configuration) utilizing a multi-processor architecture are also possible.

In some embodiments, one or more of the Bluetooth Logic 336, Wi-Fi Logic 332, and/or the Cellular Logic 334 may include its own processing element (e.g., a baseband processor, control processor, or functionally similar components), e.g., in addition to the processor(s) 302. For example, the processor(s) 302 might be (or include) an ‘application processor’ that functions to support application layer operations in the wireless device 106, while one or more of the Wi-Fi Logic 332, the Cellular Logic 334, and/or the Bluetooth Logic 336 may include a baseband processor that functions to support baseband layer operations for the applicable RAT.

As described herein, wireless device 106 may include hardware and software components for implementing embodiments of this disclosure. For example, one or more components of the wireless communication circuitry 330 (e.g., Wi-Fi logic 332, cellular logic 334, BT logic 336) of the wireless device 106 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

The block diagram illustrated in FIG. 3 is provided as one example. However, it is not intended to be limiting. Various elements and steps may be removed or performed differently. For example, a simplified wireless device 106 may only include a processor 302, memory 306, and wireless communication circuitry 330 configured to operate as a Bluetooth transceiver. An intermediate complexity wireless device 106 may comprise a processor 302, memory 306, and wireless communication circuitry 330 configured to operate as a Bluetooth transceiver and a Wi-Fi transceiver. A complex wireless device 106 may comprise all of the elements illustrated in FIG. 3, and additional components such as a display screen, display circuitry, motion detection circuitry, and the like.

### FIG. 4: Block Diagram of Wireless Communication Circuitry

FIG. 4 illustrates an example simplified block diagram of wireless communication circuitry 330, according to some embodiments. It is noted that the block diagram of the wireless communication circuitry of FIG. 4 is only one example of a possible wireless communication circuit; other circuits, such as circuits including or coupled to sufficient antennas for different RATs to perform communication activities using separate antennas, or circuits including or coupled to fewer antennas, e.g., that may be shared among multiple RATs, are also possible. According to some embodiments, wireless communication circuitry 330 may be included in a communication device, such as wireless device 106 described above.

The wireless communication circuitry 330 may couple (e.g., communicatively; directly or indirectly) to one or more antennas, such as antennas 480, 482, and 484, as shown, which may be equivalent to, or included in the set of antennas 335A and 335B of FIG. 3. In some embodiments, wireless communication circuitry 330 may include dedicated receive chains (including and/or coupled to (e.g., communicatively; directly or indirectly) dedicated processors and/or radios) for multiple RATs (e.g., a first receive chain for UWB and a second receive chain for Wi-Fi). For example, as shown in FIG. 4, wireless communication circuitry 330 may include a first modem 410 and a second modem 420. The first modem 410 may be configured for communications according to a first RAT, such as Wi-Fi, and the second modem 420 may be configured for communications according to a second RAT, e.g., such as Bluetooth.

As shown, the first modem 410 may include one or more processors 412 and a memory 416 in communication with processors 412. Modem 410 may be in communication with a radio frequency (RF) front end 430. RF front end 430 may include circuitry for transmitting and receiving radio signals. For example, RF front end 430 may include receive circuitry (RX) 432 and transmit circuitry (TX) 434. In some embodiments, RF front end 430 may be communicatively coupled to dedicated antenna 480, which may be used exclusively by the modem 410. In some scenarios, dedicated antenna 480 may include a plurality of antennas, or one or more antenna arrays.

Similarly, the second modem 420 may include one or more processors 422 and a memory 426 in communication with processors 422. Modem 420 may be in communication with an RF front end 440. RF front end 440 may include circuitry for transmitting and receiving radio signals. For example, RF front end 440 may include receive circuitry 442 and transmit circuitry 444. In some embodiments, RF front end 440 may be communicatively coupled to dedicated antenna 482, which may be used exclusively by the modem 420. In some scenarios, dedicated antenna 482 may include a plurality of antennas, or one or more antenna arrays.

In some embodiments, a switch 470 may couple RF front end 430 to shared antenna 484. In some scenarios, shared antenna 484 may include a plurality of antennas, or one or more antenna arrays. In addition, switch 470 may couple RF front end 440 to shared antenna 484. Thus, when wireless communication circuitry 330 receives instructions to transmit and/or receive according to the first RAT (e.g., as supported via the first modem 410), switch 470 may be switched to a first state that allows the first modem 410 to transmit and/or receive signals according to the first RAT (e.g., via a communication chain that includes RF front end 430 and shared antenna 484). Similarly, when wireless communication circuitry 330 receives instructions to transmit and/or receive according to the second RAT (e.g., as supported via the second modem 420), switch 470 may be switched to a second state that allows the second modem 420 to transmit and/or receive signals according to the second RAT (e.g., via a communication chain that includes RF front end 440 and shared antenna 484). In some scenarios, wireless communication circuitry 330 may receive instructions to transmit or receive according to both the first RAT (e.g., as supported via modem 410) and the second RAT (e.g., as supported via modem 420) simultaneously. In such scenarios, switch 470 may be switched to a third state that allows modem 410 to transmit and/or receive signals according to the first RAT (e.g., via a communication chain that includes RF front end 430 and shared antenna 484) and modem 420 to transmit signals according to the second RAT (e.g., via a communication chain that includes RF front end 440 and shared antenna 484). In other scenarios, simultaneous transmission of signals according to both RATs via the shared antenna 484 may not be allowed.

In some embodiments, the RF front end 430 may select between transmitting via the shared antenna 484 or the dedicated antenna 480. Similarly, the RF front end 440 may select between transmitting via the shared antenna 484 or the dedicated antenna 482. Such selections may be based on a variety of factors, such as transmission frequency of the communications, ongoing use of the shared antenna 484 by the other RF front end, antenna diversity considerations, and/or other operational considerations, e.g., as discussed below.

As described herein, the first modem 410 and/or the second modem 420 may include hardware and software components for implementing any of the various features and techniques described herein. The processors 412, 422 may be configured to implement part or all of the features described herein, e.g., by executing program instructions stored on a memory medium (e.g., a non-transitory computer-readable memory medium). Alternatively (or in addition), processors 412, 422 may be configured as a programmable hardware element, such as an FPGA (Field Programmable Gate Array), or as an ASIC (Application Specific Integrated Circuit). Alternatively (or in addition) the processors 412, 422, in conjunction with one or more of the other components 430, 432, 434, 440, 442, 444, 470, 480, 482, and 484 may be configured to implement part or all of the features described herein.

In addition, as described herein, processors 412, 422 may include one or more processing elements. Thus, processors 412, 422 may include one or more integrated circuits (I Cs) that are configured to perform the functions of processors 412, 422. In addition, each integrated circuit may include circuitry (e.g., first circuitry, second circuitry, etc.) configured to perform the functions of processors 412, 422.

In some embodiments, the wireless communication circuitry 330 may couple to only a subset of the antennas 480, 482, and 484. For example, in some scenarios, dedicated antenna 480 and/or dedicated antenna 482 may be omitted. In some embodiments, the wireless communication circuitry 330 may couple to only the shared antenna 484.

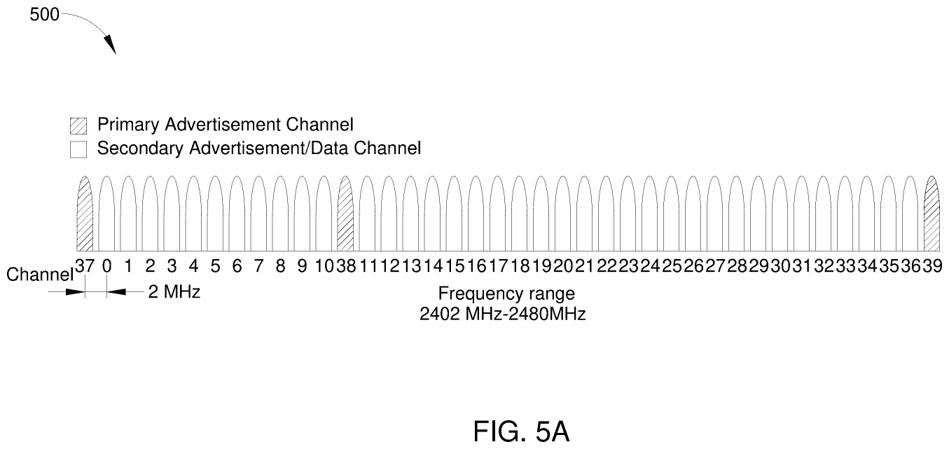

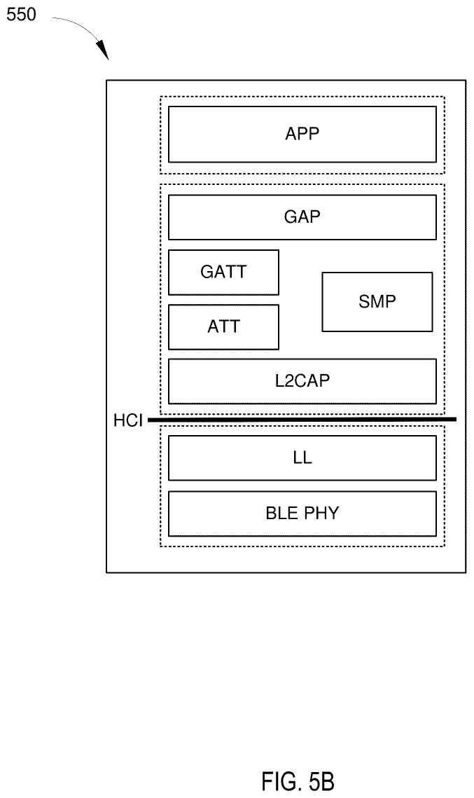

### FIGS. 5-10: Background of Bluetooth Communications

The Bluetooth Standard is one of the most prolific and successful communication standards in history. The Bluetooth standard, was first released in 1998 for short range wireless communication, typically less than 10 meters, with a transmit power of 2.5 milliwatts (mW). However, longer range communication, up to 100 meters, may be possible using Bluetooth. The standard has been continuously improved to provide, among other things, communication with higher quality of service (QOS), higher data rates, and more efficient power usage. Release 1.0 to 3.0 of the standard are referred to as Bluetooth classic (BTC). A new standard released as Rel. 4.0 is incompatible with the earlier releases, and is referred to as Bluetooth Low Energy (BLE). Both standards are still supported. BTC can transmit at higher data rates, while BLE can transmit with lower power consumption, as the name implies.

Bluetooth communication is primarily designed for communication between two wireless devices. One of the wireless devices is referred to as the primary wireless device (e.g. master device), and the other wireless device is referred to as the secondary wireless device(s) (e.g. slave device). The primary wireless device controls the clock for communication with one or more secondary devices. The primary wireless device, such as 106A in FIG. 1A, can communicate with up to 7 secondary devices, 106B . . . N to form a personal area network (PAN). Bluetooth operates in an ISM frequency band, from 2402 Megahertz (MHz) to 2480 MHz. BTC includes 80 channels that are separated by 1 MHz channels. BLE includes a frequency band 500 of 40 channels separated by 2 MHz. as shown in FIG. 5A. Selected channels, including channels 37, 38 and 39 are used for advertising and scanning to form a connection between the primary wireless device and the secondary wireless device(s). These channels are referred to as primary advertising channels. The other 37 channels, referred to as secondary advertising channels or data channels, may be used for communicating control information and data transfer between the primary wireless device 106A and the secondary wireless device(s) 106B . . . N.

FIG. 5B is an example illustration of a BLE protocol stack 550. As shown in FIG. 5A, the BLE PHY air interface operates in the same unlicensed 2.4 GHZ Industrial, Scientific, and Medical (ISM) frequency band. In some embodiments, the BLE PHY air interface operates in the range 2400 MHz to 2483.5 MHz. However, other bands may also be used, including the ISM bands of The BLE channel bandwidth is 2 MHz. The operating band is divided into 40 channels, k=0, . . . , 39. User data packets are transmitted using channels in the range [0, 36]. Advertising data packets are transmitted in channels 37, 38, and 39. A Gaussian frequency shift-keying (GFSK) modulation scheme is implemented. The BLE PHY uses frequency-hopping spread spectrum (FHSS) to reduce interference and to counter the impact of fading channels.

The Link Layer (LL) performs tasks similar to the medium access control (MAC) layer of the Open Systems Interconnection (OSI) model. In Bluetooth, the LL interfaces directly with the BLE PHY and manages the link state of the radio to define the role of a device as Central, Peripheral, Advertiser, or Scanner. The combined elements of the BLE PHY and the LL are referred to as the controller.

The host controller interface (HCI) handles the interface between the Bluetooth host and the controller. The HCI defines a set of commands and events for transmission and reception of packet data. When receiving packets from the controller, the HCI extracts raw data at the controller to send to the Bluetooth host.

The combined elements of the HCI, logical link control and adaptation protocol (L2CAP), attribute protocol (ATT), generic attribute profile (GATT), security manager protocol (SMP), and generic access profile (GAP) are referred to as the Bluetooth host.

The HCI, on the host side, handles the interface between the Bluetooth host and the controller. The HCI defines a set of commands and events for transmission and reception of packet data. When transmitting data, the HCI translates raw data into packets to send them from the Bluetooth host to the Bluetooth controller.

The L2CAP encapsulates data from the Bluetooth LE higher layers into the standard Bluetooth LE packet format for transmission or extracts data from the standard Bluetooth LE LL packet on reception according to the link configuration specified at the ATT and SMP layers.

The ATT transfers attribute data between clients and servers in GATT-based profiles. The ATT defines the roles of the client-server architecture. The roles typically correspond to the Central and the Peripheral as defined in the link layer. In general, a device could be a client, a server, or both, irrespective of whether it is a Central or a Peripheral. The ATT also performs data organization into attributes as shown in this figure.

The GATT provides a reference framework for all GATT-based profiles. The GATT encapsulates the ATT and is responsible for coordinating the exchange of profiles in a Bluetooth LE link. Profiles include information and data such as handle assignment, a UUID, and a set of permissions.

For devices that implement the GATT profile, the client is the device that initiates commands and requests toward the server. The client can receive responses, indications, and notifications. The server is the device that accepts incoming commands and requests from the client. The server sends responses, indications, and notifications to the client. The GATT uses a client-server architecture. The roles are not fixed and are determined when a device initiates a defined procedure. Roles are released when the procedure ends.

The SMP applies security algorithms to encrypt and decrypt data packets. This layer defines the initiator and the responder, corresponding to the Central and the Peripheral, once the connection is established.

The GAP specifies roles, modes, and procedures of a device. It also manages the connection establishment and security. The GAP interfaces directly with the Application Profiles and Services (APP) layer.

The App layer is the direct user interface defining profiles that afford interoperability between various applications. The Bluetooth core specification enables vendors to define proprietary profiles for use cases not defined by SIG profiles.

The example illustration of the BLE protocol stack in FIG. 5B is not intended to be limiting. Other layer setups can also be used, including the BTC protocol stack.

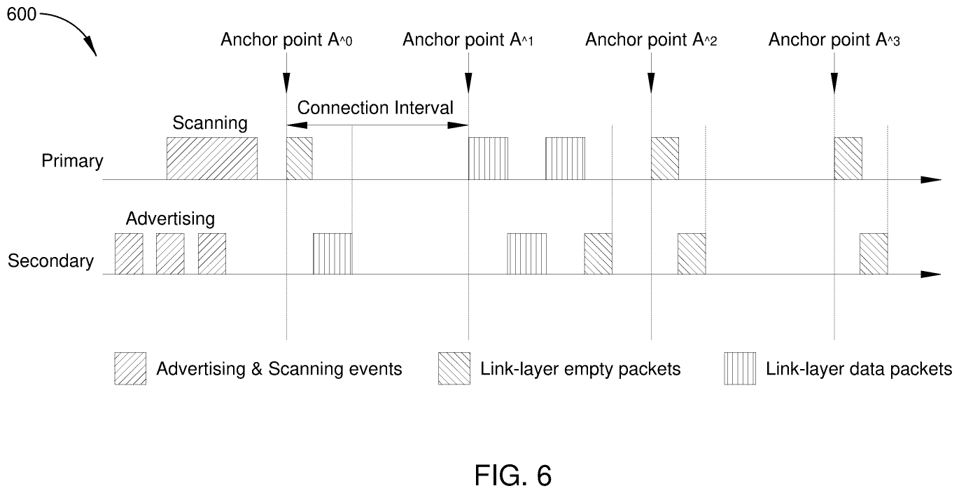

FIG. 6 is an example illustration of a communication 600 between a primary wireless device 106A and a secondary wireless device 106B for Bluetooth BLE. In this example, the secondary wireless device 106B broadcasts a series of advertising packets. The primary wireless device scans for the advertising packets. When an advertising packet is received, the information in the advertising packet is used to form a connected mode between the wireless devices 106A, and 106B . . . N. During the connected mode, the primary wireless device and the secondary wireless device(s) 106B . . . N can both transmit and receive data and control information on channels 0 to 36. Each transmission starts at an anchor point. The anchor point is used to synchronize a clock between the two devices. For example, the secondary wireless device 106B can use the last anchor point and an offset to calculate its next anchor point time, along with transmit and receive times.

The period between the two anchor points, such as A0 and A1 in FIG. 6, is referred to as a connection interval. During the connection interval, the primary wireless device 106A and the secondary wireless device 106B can transmit and receive link-layer packets. The primary wireless device can transmit the first link-layer packet. The length of the transmission is less than the length of the connection interval. The secondary wireless device can then respond by transmitting a link-layer packet to the primary wireless device.

There are two types of link-layer packets. The first type of packet, a link-layer data packet, is a packet that includes data in the payload of the packet. The wireless devices can also transmit packets that don't include data, which are referred to as link-layer empty packets. The link-layer empty packet can include header information in the packet. The last communication in a connection interval can be from the secondary wireless device 106B, which is typically a link-layer empty packet indicating that there is no further data to transmit and confirming the end of a connection event between the primary wireless device 106A and the secondary wireless device(s) 106B . . . N.

The example of FIG. 6 is not intended to be limiting. There are a number of different types of communication that can take place according to one or more of the Bluetooth specifications. Rather, the example of FIG. 6 is used to illustrate the connection of two Bluetooth configured devices, such as the primary wireless device 106A and the secondary wireless device 106B and the transmission of packets between the devices.

As previously discussed, communication in the ISM 2.4 GHz band can be very crowded, with a number of different types of communication standards and devices that use the ISM bands, including but not limited to Bluetooth, IEEE 802.11, wireless intercoms, walkie talkies, and microwave ovens. Each of these devices can create interference and/or noise in one or more channels of the Bluetooth frequency band.

To manage interference, Bluetooth uses adaptive frequency hopping (AFH) using, for example, frequency hopping spread spectrum (FHSS). With AFH, the transmitter and receiver hop to a different channel on a periodic basis. If potential interference is only affecting some of the 80 channels for BTC or 40 channels for BLE, the frequency hopping can be effective in providing open channels for communication.

In order for the transmitter and receiver(s) to be synchronized to enable synchronous channel hopping, the hopping pattern can be derived from the clock and Bluetooth device address of the primary wireless device 106A. The secondary wireless device clock is synchronized to the primary wireless device clock by adding an offset to the secondary wireless devices' native clock. The offsets are updated regularly, since the device clocks are independent. Thereby all devices within a Bluetooth personal area network (e.g. 106A and 106B . . . N) are time and frequency synchronized.

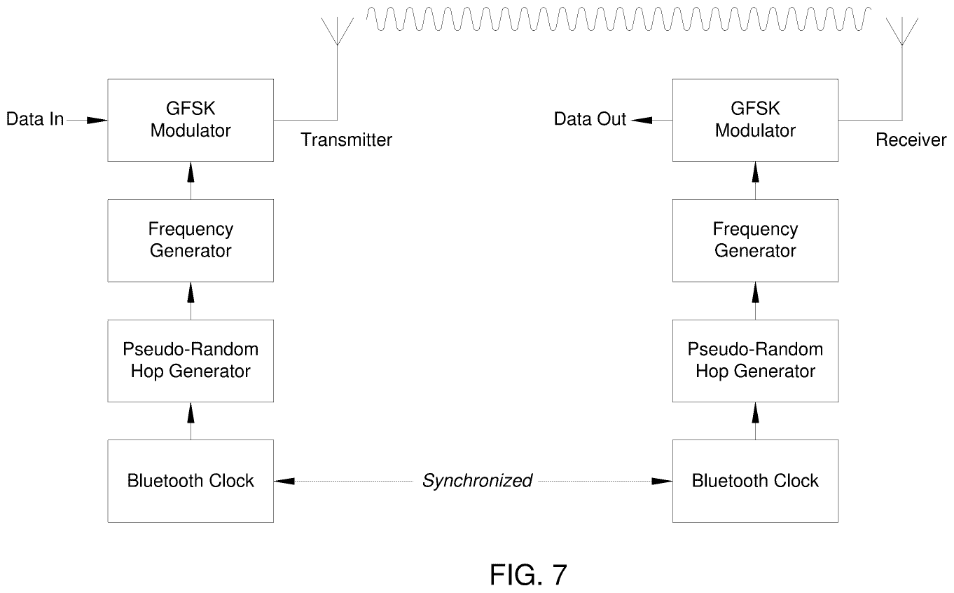

A typical setup with a Bluetooth transmitter and a Bluetooth receiver both synchronized is shown in the block diagram illustrated in FIG. 7, in which a gaussian frequency shift keying (GFSK) modulator is used. This example is not intended to be limiting. Other types of frequency shift keying or phase shift keying modulators may also be used.

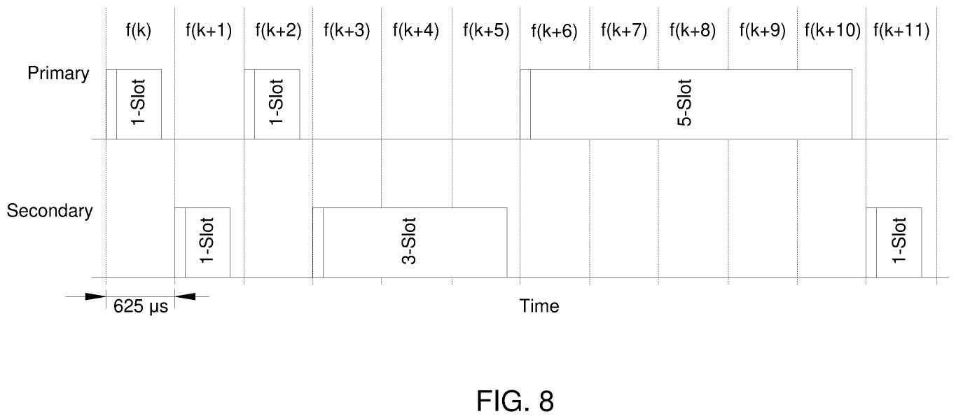

FIG. 8 provides an example illustration of a multi-slot packet transmission and frequency hop scheme. As shown in FIG. 8, Bluetooth transmission channels are divided into time slots, with each slot being 625 us in length. The slots are numbered according to the most significant 27 bits of the BT clock. The time slot number, denoted as “k”, therefore ranges from 0 to 227-1. With the time slot period of 625 μs, if the wireless devices hop to a new channel every slot, it will result in 1600 hops per second. Bluetooth packets can be either 1, 3, or 5 slots in duration. Accordingly, the frequency hopping rate can be dependent on the length of the packets transmitted between the primary wireless device 106A and the secondary wireless device(s) 106B . . . N.

In order to synchronize the channel hopping for AFH, both the primary wireless device 106A and the secondary wireless device(s) 106B . . . N can use the same pseudo-random number generator. Bluetooth uses two types of channel selection algorithms (CSAs) to determine the channel for both the primary wireless device and the secondary wireless device(s). The second CSA algorithm was introduced in Bluetooth release 5.0. Devices that are configured for earlier releases use the first CSA algorithm.

Each CSA uses the same pseudo-random number generator sharing the same parameters, so the primary wireless device 106A and the secondary wireless devices 106B . . . N are able to hop to the same channel for every slot or connection event. By continuously hopping to another channel for each new slot or connection event, the BLE devices are able to avoid interference from the last connection channel, if any.

The term ‘Adaptive’ in AFH comes from the ability of the primary wireless device 106A and all secondary wireless devices 106B . . . N within a PAN to be able to monitor channel conditions and avoid bad channels, if necessary. The channel quality measurements may be made by all devices within the PAN, since interference depends on the device location and transmitted power.

Common metrics for performing measurements on receive channel quality include a measurement of the Received Signal Strength Indication (RSSI) for the bits in a Packet, a measurement of the Bit Error Rate (BER) over a selected period, or a measurement of the Signal to Noise Ratio (SNR) over a selected period. The Bluetooth Core Specification does not mandate the method of channel measurement in order to identify a good channel or a bad channel. Instead, the implementation is left up to the vendor to define or optimize.

A channel noise map, also referred to as a channel interference bitmap, may be created and provided by the primary wireless device 106A. The term “noise” can comprise noise, such as thermal noise, along with radio frequency noise and interference that is occurring within the channel. The bitmap contains the relevant information about the 79/40 frequency channels for BTC and BLE. The channel classification as either a good or bad channel may be based on: a) local measurements (e.g. active or passive assessment in the Controller) b) information from the primary wireless device; or c) report messages in PDUs received from the secondary wireless devices. Used channels are stated as blocked with the return value of 0. Unused channels are stated as clear with a return value of 1, or vice versa.

In one example, the channel inference bitmap is controlled by the primary wireless device 16A. The channel noise bitmap can be communicated to each of the secondary wireless device(s) 106B . . . N. The channel noise bitmap can be actively updated by the primary wireless device and communicated to the secondary wireless device(s). An example channel bitmap for BLE is illustrated below in Table 1. It should be noted that the channel bitmap can also include the advertising/scanning channels of channel 37, 38 and 39. For BTC, the channel bitmap can be extended to cover 80 channels.

TABLE 1

| Channel | Available |
|---|---|
| 0 | 0 |
| 1 | 1 |
| 2 | 1 |
| 3 | 1 |
| 4 | 0 |
| 5 | 0 |
| 6 | 1 |
| . . . | . . . |
| 37 | 0 |
| 38 | 1 |
| 39 | 1 |
| . . . | . . . |
| 79 | 1 |

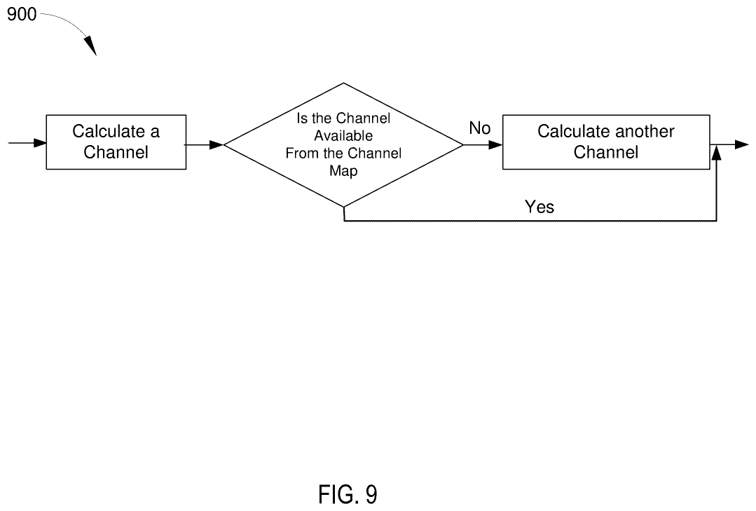

When the channel noise bitmap is used, the CSA can use the flowchart 900 illustrated in FIG. 9. In accordance with some embodiments, the CSA can calculate a channel. For example, the channel may be calculated using a pseudo random number generator. The CSA can then determine if the channel is available from the channel noise bitmap. The channel may be available, or clear, if the bit value for the channel in the bitmap is “1” and unavailable, or blocked if the bit value for the channel in the bitmap is “0”, or vice versa. If the channel is available, then the channel can be used for transmission and reception between the primary wireless device 106A and secondary wireless device(s) 106B . . . N. If the channel is not available, then the CSA can generate the next channel for the primary wireless device and the secondary wireless device(s). The flow chart process can be repeated again until a channel is available.

In some embodiments, the primary wireless device 106A and the secondary wireless device(s) 106B . . . N may share the same channel noise bitmap that is updated by the primary wireless device. The BLE devices may not use blocked channels until they are unblocked again. The channel noise bitmap sets all channels available by default at the beginning of a connection. The channel noise bitmap may be updated after entering the connection-oriented communication after the advertising and scanning is performed and a connection is made between the wireless devices. The primary wireless device can update the channel map without being requested.

As previously discussed, the Bluetooth Core Specification does not mandate the method of channel measurement in order to identify a good channel (e.g. an available channel) or a bad channel (e.g. an unavailable channel). Nor does the specification mandate how often the bitmap is to be updated. Instead, the implementation is left up to the vendor to define or optimize. However, the specification does suggest, for vendors that use the bitmap, that transmission may only be performed when there are 20 or more channels available for frequency hopping for BLE systems, or 40 or more channels available for frequency hopping for BTC systems.

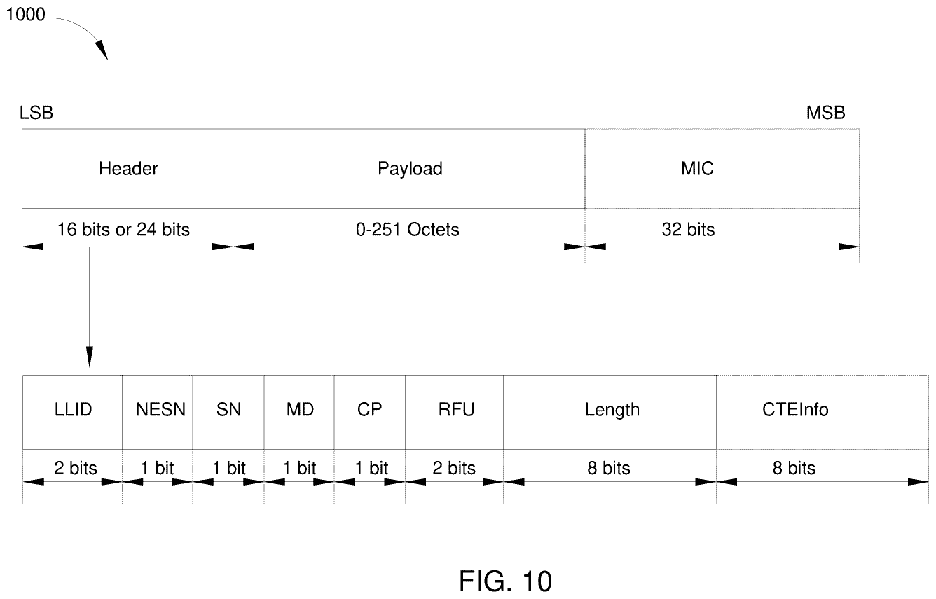

FIG. 10 provides an example illustration of a BLE link layer control protocol data unit (PDU), also referred to as a data physical channel PDU. The PDU 1000 comprises: a header, which can be either 16 or 24 bits; a payload which can be from 0 to 251 octets; and a message integrity check (MIC) field that comprises 32 bits.

The header of the PDU 1000 comprises 8 fields. The description of the fields is not intended to be limiting. Rather, the description is intended to provide examples of a BLE link layer (LL) PDU header.

A 2 bit link layer identification (LLID) field in the PDU 1000 header may indicate whether the packet is a link-layer data PDU or a link layer control PDU.

A 1 bit next expected sequence number (NESN) field is used by the link layer to either acknowledge the last data physical channel PDU sent by the peer (e.g. primary or secondary wireless device) or to request the peer to resend the last data physical channel PDU. This will be described more fully below.

A 1 bit sequence number (SN) field is used by the link layer to identify the BLE packets sent by it.

A 1 bit more data (MD) field indicates that the primary or secondary wireless device has more data to send. If neither of the primary and secondary device has set the MD bit in their packets, the packet from the secondary wireless device closes the connection event, as described in FIG. 6. If the primary and secondary wireless devices have set the MD bit, the primary wireless device can continue the connection event by sending another packet, and the secondary wireless device can listen after sending its packet.

A constant tone extension information (CTEInfo) present (CP) field indicates whether the data physical channel PDU header has a CTEInfo field and, subsequently whether the data physical channel packet has a CTE.

A length field indicates the size, in octets, of the payload and MIC, if present. The size of this field is in the range [0, 255] octets.

A CTEInfo field indicates the type and length of the CTE. The number of symbols in the CTE field are configured by higher layers so that a suitable amount of data and time is available for IQ sampling.

When PDUs are transmitted by the primary wireless device to the secondary wireless device, or vice versa, there is an acknowledgment process used to indicate to the sender that the PDU was successfully received and decoded. In BLE, the acknowledgement process is performed using the NESN and SN fields in the header, such as the header illustrated in FIG. 10.

In one example, the NESN and SN are used for data flow and making sure data is not missed (ACKs and NACKs). The NESN and SN fields are independently appraised. When a sending wireless device sends a packet, the NESN is the next expected SN from the other side in the next packet coming back. When the device receives a packet it looks at the NESN field value and compares it to the previous SN that it sent. If the values are different then that means that it's an acknowledgement (ACK), indicating that the other side received, decoded, and accepted the previous packet correctly. If the NESN and SN are the same (e.g. both 0 or both 1), that means that the sender NACK′ed the previous packet (either didn't receive, couldn't decode it, or rejected the packet because of a lack of buffer space) which triggers a resend of the previous data packet that the wireless device had sent. The device also looks at the SN, and if it was the same as the previous NESN (expected sequence number from the other side) that it sent, then it's expected data. Otherwise, that means the data is old and can be discarded.

Accordingly, when a packet, such as a BLE packet is transmitted from a primary wireless device to a secondary wireless device, or vice versa, and the packet is not correctly received and acknowledged, then the wireless device that transmitted the packet re-sends the packet. The wireless device that received the packet typically starts the reception process over and attempts to decode the transmitted packet again.

In some wireless environments, the noise and/or interference in the wireless environment makes it difficult to receive a packet. Most wireless devices are designed to receive a packet with a signal to noise ratio (SNR), signal to interference plus noise ratio (SINR), or another desired metric, that is greater than a selected threshold value.

If the SNR or SINR is less than the threshold, there may not be enough energy in the signal relative to the noise and/or interference for the receiver to correctly identify the bits in the packet. In the current BLE specifications, the receiving device signals, via the SN and NESN fields, that a packet, such as the PDU, needs to be re-sent by the transmitting device. The receiving device then attempts to decode the PDU a second time. If the noise and/or interference is lower, and/or the signal power is higher, (e.g. a greater SNR or SINR), then the receiving device may be able to correctly decode the re-transmitted packet. However, if the SNR or SINR is lower, then the receiving device may not be able to correctly decode the re-transmitted packet. If the packets are not able to be decoded over a period of time, then the link between the transmitting device and the receiving device may fail.

### FIGS. 11-13: Wi-Fi Background

The Wi-Fi standard was first released in 1997. As with Bluetooth, wireless devices configured to operate using Wi-Fi also operate in the ISM bands. While Bluetooth configured devices typically communicate in a peer to peer connection, Wi-Fi configured devices can communicate with an access point (AP) 102 that is connected to a network 100 such as the internet, a private network, or a public network. APs can communicate at higher power levels than Bluetooth configured devices. A maximum output power for an AP is 100 milliwatts (mW), or 20 dBm. Shorter range peer to peer communication using Wi-Fi may be performed at lower power levels. Wi-Fi networks are commonly referred to as local area networks (LANs), which are larger than PANs.

The original Wi-Fi standards, from the original IEEE 802.11-1997 standard to the most current IEEE 802.11be (Wi-Fi 7) standard, released on Jan. 8, 2024, cover a number of different ISM bands. In the United states, ISM bands that are currently used include the 2.4 GHz band, with 100 MHz of bandwidth from 2400 MHz to 2500 MHz, which overlaps with the bands used in Bluetooth. The 2.4 GHz band only has 3 non-overlapping channels. However, there are a 14 channels total, including 11 overlapping channels. The 14 channels are spaced 5 MHz apart. The so called “5 GHz band” operates with 150 MHz of bandwidth from 5725 MHz to 5875 MHz, with 23 non-overlapping channels. The 2.4 GHz band and the 5 GHz band are ISM bands that are available in North America, Europe, and Japan. The “6 GHz band” operates in a non-ISM band at low power levels, and with a much greater bandwidth of 1180 MHz, from 5945 MHz to 7125 MHz. There are 59 channels with 20 MHz in the 6 GHz band, with additional channels having 40, 80, or 160 MHz. Two adjacent 160 MHz channels are used to form 320 MHz channels in Wi-Fi 7. Wi-Fi also operates in additional bands in various locations throughout the world, including but not limited to a 3.6 GHz band, from 3550 MHz to 3700 MHz, and a 900 MHz band. However, these bands are not commonly used.

Wi-Fi communication uses datagrams referred to as frames. Each frame comprises a medium access control (MAC) header, a potential payload, and a frame check sequence (FCS). As with Bluetooth communication, some Wi-Fi frames do not have payloads.

### FIG. 11A: Wi-Fi MAC Header

An example illustration of an IEEE 802.11 Wi-Fi MAC header 1100 is illustrated in FIG. 11A. The first two bytes of the MAC header form a frame control field specifying the form and function of the frame. This frame control field is subdivided into the following sub-fields: a Protocol Version: Two bits representing the protocol version. The currently used protocol version is zero. Other values are reserved for future use. Two bits are used to identify the “Type” of the WLAN frame. The WLAN frame type can be one of Control, Data, or Management frames, as defined in IEEE 802.11. A Subtype consists of four bits providing additional discrimination between frames. Type and Subtype are used together to identify the exact frame. Two bits are used to identify whether a data frame is headed towards a distribution system (ToDS) or exiting the distribution system (FromDS). Control and management frames et these values to zero. The data frames have one of these bits set as follows:
ToDS=0 and FromDS=0-Designates communication within a basic service set or an independent basic service set (IBSS) network.
ToDS=0 and FromDS=1-Designates a frame sent by a station (wireless device) and directed to an AP accessed via the distribution system.
ToDS=1 and FromDS=0-Designates a frame exiting the distribution system for a station.
ToDS=1 and FromDS=1-Designates the only kind of frame that uses all four MAC addresses in a DATA frame: Address 1 is the access point address exiting from the distribution system; Address 2 is the access point entrance to the distribution system (e.g. the AP to which the source station is connected); Address 3 is the final station address; and Address 4 is the address of the source station.

A More Fragments bit is set when a packet is divided into multiple frames for transmission. Every frame except the last frame of a packet will have this bit set.

A Retry bit is set to one when a frame is retransmitted.

A power management bit indicates the power management state of the sender after the completion of a frame exchange. Access points manage the connection and typically don't set the power-saver bit.

A More Data bit is used to buffer frames received in a distributed system. The access point uses this bit to facilitate stations in power-saver mode. It indicates that at least one frame is available and addresses all stations connected.

A Protected Frame bit is set to the value of one if the frame body is encrypted by a protection mechanism such as Wired Equivalent Privacy (WEP), Wi-Fi Protected Access (WPA), or Wi-Fi Protected Access II (WPA2).

An Order bit is set only when a “strict ordering” delivery method is employed. Frames and fragments are not always sent in order as doing so can cause a transmission performance penalty.

The next two bytes are reserved for the Duration ID field, indicating how long the field's transmission will take so that other devices will know when the channel will be available again. This field can take one of three forms: Duration, Contention-Free Period (CFP), and Association ID (AID).

An 802.11 frame can have up to four address fields. Each field can carry a MAC address. Address 1 is the receiver, Address 2 is the transmitter, Address 3 is used for filtering purposes by the receiver. Address 4 is only present in data frames transmitted between access points in an Extended Service Set or between intermediate nodes in a mesh network.

A Sequence Control field is a two-byte section used to identify message order and eliminate duplicate frames. The first 4 bits are used for the fragmentation number, and the last 12 bits are the sequence number.

An optional two-byte Quality of Service (QOS) control field, present in QoS Data frames, was added with IEEE 802.11e.

The payload or frame body field is variable in size, from 0 to 2304 bytes plus any overhead from security encapsulation. The frame body field can also contain information from higher layers.

The Frame Check Sequence (FCS) is the last four bytes of the MAC header 1100 in the standard IEEE 802.11 frame. Often referred to as the Cyclic Redundancy Check (CRC), the FCS allows for integrity checks of retrieved frames. As frames are about to be sent, the FCS is calculated and appended. When a station receives a frame, it can calculate the FCS of the frame and compare it to the one received. If they match, it is assumed that the frame was not distorted during transmission. If the calculated FCS does not match, then the frame can be requested to be retransmitted.

### FIG. 11B: Management, Control, and Data Frames

As previously discussed, the MAC header can be associated with 3 different types of frames-management, control, and data frames.

A management frame allows for the maintenance, or discontinuance, of communication. There are a number of different types of subframes in a management frame. Some of the common IEEE 802.11 management frame subtypes are described in the proceeding paragraphs. The body of a management frame consists of frame-subtype-dependent fixed fields followed by a sequence of information elements (IEs). An example of an IE 1150 is illustrated in FIG. 11B.

An authentication frame is used to associate a wireless device 106A with an AP. In IEEE 802.11, authentication begins with the wireless network interface controller (WNIC) in a wireless device (e.g. Wi-Fi Logic 332, FIG. 3) sending an authentication frame to the access point containing its identity. When open system authentication is being used, the WNIC sends only a single authentication frame, and the access point responds with an authentication frame of its own indicating acceptance or rejection. When shared key authentication is being used, the WNIC sends an initial authentication request, and the access point responds with an authentication frame containing challenge text. The WNIC then sends an authentication frame containing the encrypted version of the challenge text to the access point. The access point confirms the text was encrypted with the correct key by decrypting it with its own key. The result of this process determines the WNIC's authentication status.

An association request frame (ARF) is sent from a wireless device 106A, referred to as a Station, or STA. The ARF enables the AP to allocate resources and synchronize. The ARF carries information about the WNIC, including supported data rates and the service set identifier (SSID) of the network the wireless device wishes to associate with. If the request is accepted, the AP reserves memory and establishes an association ID for the WNIC.

An association response frame is sent from an AP to a wireless device 106A containing the acceptance or rejection to an association request. If it is an acceptance, the frame will contain information such as an association ID and supported data rates.

A Beacon frame is sent periodically from an AP to announce its presence and provide the SSID and other parameters for WNICs within range.

A de-authentication frame is sent from a wireless device 106A wishing to terminate a connection with another wireless device 106B . . . N.

A disassociation frame is sent from a wireless device 106A wishing to terminate the connection. It is an elegant way to allow the AP to relinquish memory allocation and remove the WNIC from an association table.

A probe request frame is sent from a wireless device 106A when it desires information from another wireless device 106B . . . N.

A probe response frame is sent from an AP 102 containing capability information, supported data rates, etc., after receiving a probe request frame.

A re-association request is sent by a WNIC in a reassociation request frame when it drops from the currently associated access point range and finds another AP with a stronger signal. The new AP coordinates the forwarding of any information that may still be contained in the buffer of the previous AP.

A reassociation response frame is sent from an AP containing the acceptance or rejection to a WNIC reassociation request frame. The frame includes information used for association such as the association ID and supported data rates.

An action frame is used to extend a management frame to control a certain action. Some of the action categories are Block Ack, Radio Measurement, Fast basic service set (BSS) transition, etc. These frames are sent by a wireless device 106A when it needs to tell its peer for a certain action to be taken. For example, a wireless device 106A can tell another wireless device 106B . . . N to set up a block acknowledgement by sending an Add Block ACK (ADDBA) Request action frame. The other wireless device 106B . . . N would then respond with an ADDBA Response action frame.

In addition to the management frame, control frames are communicated to facilitate the exchange of data frames between wireless devices 106A . . . N. Some common IEEE 802.11 control frames are described in the proceeding paragraphs. Their description is not intended to be limiting. Other control frames than those described herein are may also be used to perform Wi-Fi communication.

An acknowledgement (ACK) frame is used to verify that frames have been successfully received. After receiving a data frame, the receiving wireless device will send an ACK frame to the sending wireless device or AP if no errors are found. If the sending wireless device does not receive an ACK frame within a predetermined period of time, the sending wireless device will resend the frame.

Request to Send (RTS) frame: the RTS and CTS frames provide an optional collision reduction scheme for access points. A wireless device 106A can send an RTS frame as a first step in a two-way handshake that is used before sending data frames.

Clear to Send (CTS) frame: a wireless device or AP responds to an RTS frame with a CTS frame. It provides clearance for the requesting station to send a data frame. The CTS provides collision control management by including a time value for which all other stations are to hold off transmission while the requesting wireless device or AP transmits.

### FIG. 12: IEEE 802 Reference Model

FIG. 12 provides an example illustration of the IEEE 802 reference model 1200 relative to the OSI reference model. As illustrated, the IEEE 802 reference model only standardizes the OSI physical layer and the data link layer. The remaining layers in the OSI reference mode, including the network, transport, session, presentation, and application layers, are typically implemented using software.

The data link layer comprises two sub-layers, a MAC layer and a logical link control (LLC) layer. These layers can be accessed by a Wi-Fi host comprising upper layer protocols using the LLC service access point (LSAP). The PHY layer also comprises two sub-layers, physical layer convergence protocol (PLCP) and the physical medium dependent (PMD) layer. The LLC layer may be implemented using software and/or hardware. While the MAC layer and PHY layers are typically implemented in hardware.

The IEEE 802.11 specification uses the same 802.2 LLC and 48-bit addressing as other IEEE 802 LANs, allowing for very simple bridging from wireless to IEEE wired networks, but the MAC in IEEE 802.11 is unique to WLANs.

The 802.11 MAC is designed to support multiple users on a shared medium by having the sender sense the medium before accessing it. For IEEE 802.3 Ethernet LANs, the Carrier Sense Multiple Access with Collision Detection (CSMA/CD) protocol regulates how Ethernet stations establish access to the wire and how they detect and handle collisions that occur when two or more devices try to simultaneously communicate over the LAN.

However, there are three issues that arise with wireless communication. The first is called the near/far problem. To detect a collision, a station must be able to transmit and listen at the same time. However, at a wireless transmitter, such as an IEEE 802.11 access point (AP), the transmission power of the radio system drowns out the ability of the station to hear a collision. The second issue, called the hidden node issue, occurs when two wireless devices (e.g. 106A and 106N) on opposite sides of an AP 102 can both hear activity from the AP 102, but not hear activity from each other, usually due to distance or an obstruction. The third issue is the constraint of power in wireless devices. Since many wireless devices are portable, and therefore relatively small and lightweight, they have limited power from their batteries.

To deal with these issues, the IEEE 802.11 MAC was designed with a Carrier Sense Multiple Access with Collision Avoidance (CSMA/CA) or the Distributed Coordination Function (DCF). With CSMA/CA, a wireless device that would like to transmit first senses the medium, and, if no activity is detected, the wireless device waits an additional, randomly selected period of time and then transmits if the medium is still free. CSMA/CA reduces the probability that two or more stations will begin transmitting at the same time and ensures some degree of fairness.

However, CSMA/CA cannot guarantee that a collision does not occur. To determine if a collision has occurred, in which two signals arrive at a receiving wireless device at the same time, the IEE 802.11 specification uses an explicit acknowledgement (ACK) to ensure transmission correctness. An ACK packet is sent by the receiving wireless device to confirm that the data packet arrived intact. If the packet is received intact, the receiving station issues an ACK frame that, once successfully received by the sender, completes the process. If the ACK frame is not detected by the transmitting wireless device, either because the original data packet was not received intact or the ACK was not received intact, a collision is assumed to have occurred and the data packet is transmitted again after waiting another random amount of time.

Accordingly, CSMA/CA provides a way of sharing access over the air. This explicit ACK mechanism also handles interference and other radio-related problems very effectively. However, it does add some latency to wireless communications using the IEEE 802.11 specification that the IEEE 802.3 does not have, so that an 802.11 LAN will always have slower performance than an equivalent Ethernet LAN.

To address the “hidden node” issue, the IEEE 802.11 specifies an optional Request to Send/Clear to Send (RTS/CTS) protocol at the MAC layer. When this feature is in use, a transmitting wireless device transmits an RTS and waits for the access point to reply with a CTS. Since all stations in the network can hear the access point, the CTS causes them to delay any intended transmissions, allowing the transmitting wireless device to transmit and receive a packet acknowledgment without any chance of collision. Since RTS/CTS adds additional overhead to the network by temporarily reserving the medium, it is typically used only on the largest-sized packets, for which retransmission would be expensive from a bandwidth standpoint.

The MAC layer communicates with the Physical Layer Convergence Protocol (PLCP) sublayer via primitives (a set of commands or “fundamental instructions”) through a service access point (SAP). When the MAC layer instructs it to do so, the PLCP prepares MAC protocol data units (MPDUs) for transmission. The PLCP minimizes the dependence of the MAC layer on the PMD sublayer by mapping MPDUs into a frame format suitable for transmission by the PMD. The PLCP also delivers incoming frames from the wireless medium to the MAC layer. The PLCP appends a PHY-specific preamble and header fields to the MPDU that contain information needed by the Physical layer transmitters and receivers. The 802.11 standard refers to this composite frame (the MPDU with an additional PLCP preamble and header) as a PLCP protocol data unit (PPDU). The MPDU is also called the PLCP Service Data Unit (PSDU), and is typically referred to as such when referencing physical layer operations. The frame structure of a PPDU provides for asynchronous transfer of PSDUs between stations. As a result, the receiving station's Physical layer must synchronize its circuitry to each individual incoming frame.

Under the direction of the PLCP, the Physical Medium Dependent (PMD) sublayer provides transmission and reception of Physical layer data units between two wireless devices (e.g. 106A and 106B) via the wireless medium. To provide this service, the PMD interfaces directly with the wireless medium and provides modulation and demodulation of the frame transmissions. The PLCP and PMD sublayers communicate via primitives, through a SAP, to govern the transmission and reception functions.

Both MAC and PHY layers conceptually include management entities, referred to as the MAC Layer Management Entity (MLME), and the Physical Layer Management Entity (PLME). These entities provide the layer management service interfaces through which layer management functions may be invoked. In order to provide correct MAC operation, a station management entity (SME) is typically present within each wireless device. The SME is a layer-independent entity that may be viewed as residing in a separate management plane or as residing “off to the side.” The exact functions of the SME are not specified in the 802.11 standard, but in general this entity may be viewed as being responsible for such functions as the gathering of layer dependent status from the various layer management entities, and similarly setting the value of layer-specific parameters. The SME would typically perform such functions on behalf of general system management entities and would implement standard management protocols.

At the physical layer, the Transmit (Tx) procedure is used to send individual octets of the data frame. The transmit procedure is invoked by the CS/CCA procedure immediately upon receiving a PHY-TXSTART.request (TXVECTOR) from the MAC sublayer. The CSMA/CA protocol is performed by the MAC with the PHY PLCP in the CS/CCA procedure prior to executing the transmit procedure.

The Receive (Rx) procedure is used to receive individual octets of the data frame. The receive procedure is invoked by the PLCP CS/CCA procedure upon detecting a portion of the preamble sync pattern followed by a valid SFD and PLCP Header. Although counter-intuitive, the preamble and PLCP header are not “received”. Only the MAC frame is “received”.

In accordance with some embodiments, a wireless device 106A . . . N is configured to communicate using multiple communication specifications, including the Bluetooth specification and the IEEE 802.11 Wi-Fi specification. Each communication specification provides advantages and disadvantages relative to each other. For example, the Bluetooth specification enables data to be communicated with low latency and low power. However, the communication can be at relatively low data rates, typically less than 3 megabits per second (Mb/s). The Wi-Fi specification enables data to be communicated at relatively high data rates, at multiple gigabits per second (Gb/s) over longer distances that Bluetooth, enabling data to be received throughout a multi-room house or building. However, there can be a relatively long latency to begin communicating over a Wi-Fi channel due to the CS/CCA procedure. The use of RTS/CTS can provide even longer latency. Certain types of extended reality (XR) applications, such as virtual reality (VR), augmented reality (AR), and mixed reality (MR) need low latency communication to perform properly. Even tens of milliseconds of additional latency can have substantial effects on a user of XR applications, sometimes causing nausea and motion sickness.

In some embodiments, to minimize latency in communication between wireless devices 106A . . . N, a Bluetooth communication between two or more wireless devices 106A . . . 106N can be used to assist peer to peer Wi-Fi communication, such as Apple Wireless Direct Link, between the two or more wireless devices 106A . . . N.

### FIG. 13: BT Communication for Sending Wi-Fi Information Between Wireless Devices

FIG. 13 provides an example illustration of a Bluetooth communication used to send Wi-Fi information between two or more wireless devices 106A . . . 106N. In this example, two or more wireless devices may be configured to establish a peer to peer Wi-Fi communication link between the two or more wireless devices 106A . . . 106N for a low latency application. The two or more wireless devices can have a pre-established Bluetooth connection between the wireless devices. In this example, control data can be communicated from one of the two or more wireless devices 106A to the other wireless device(s) 106B . . . N. The control data can comprise the information needed to establish a Wi-Fi connection between the wireless devices 106A . . . N. In one example, the information can be used to establish communication over a predetermined Wi-Fi channel at a predetermined time. As illustrated in the example of FIG. 8, each Bluetooth packet can be communicated in a slot having a width of 625 microseconds. Accordingly, the control data can be received at the other wireless device(s) 106B . . . N and the devices can be setup to receive and/or transmit over the selected Wi-Fi channel at the selected time period. The wireless devices 106A . . . N can then commence Wi-Fi communication using the information received over the Bluetooth connection. The Wi-Fi communication may be performed without typical Wi-Fi setup and establishment issues, including the time to perform the CS/CCA procedure, select a modulation and coding scheme (MCS), determine a Wi-Fi channel, setup encryption keys, and so forth. The latency can be decreased from potentially 10s of milliseconds to less than 1 ms. However, even a latency decreased from 10s of milliseconds to 1 to 5 ms can be useful with low latency applications.

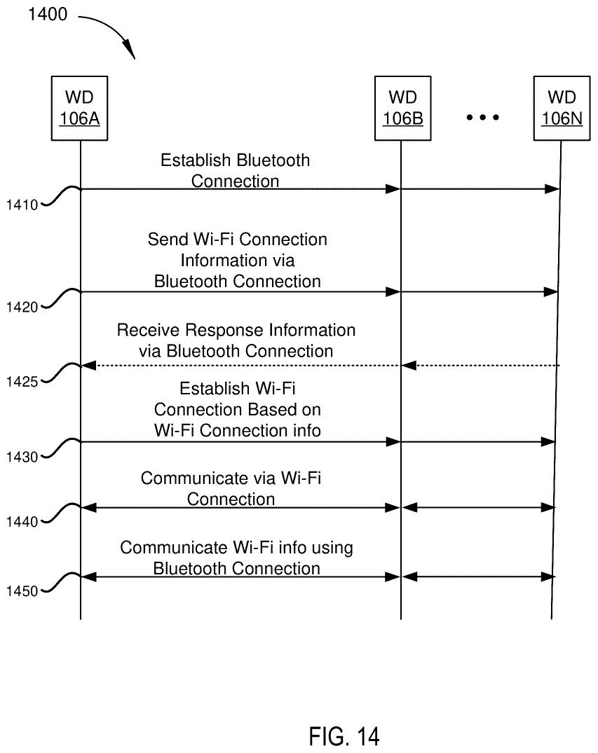

### FIG. 14: Example Communication Diagram Between Wireless Devices

FIG. 14 provides an example communication diagram 1400 between wireless devices 106A . . . N in which Bluetooth communication is used to establish a Wi-Fi link between two or more wireless devices. In some embodiments, a first wireless device 106A establishes a Bluetooth wireless connection with one or more additional wireless device(s) 106B . . . N, as shown in 1410. The first wireless device 106A may be a primary wireless device. The additional wireless device(s) may be secondary wireless device(s). The primary wireless device 106A may broadcast to the additional wireless device(s) 106B . . . N to form one or more connections between the two or more wireless devices. Alternatively, the primary wireless device may communicate separately to the other wireless device(s) 106B . . . N. The wireless device 106A may also be a secondary wireless device that forms a Bluetooth connection with a primary wireless device.

In some embodiments, the wireless device 106A can send Wi-Fi information to the other wireless device(s) 106B . . . N via the Bluetooth connection, as shown in 1420. The Wi-Fi information may be information that is used to form a Wi-Fi connection between the Wireless device 106A and the other wireless device(s) 106B . . . N. The Wi-Fi connection information can comprise information that may be included in a Wi-Fi MAC header, such as MAC header 1100, including information that is typically communicated in one or more of a control frame, data frame, or management frame. In some embodiments, the other wireless device(s) 106B . . . N can send a response message back to the first wireless device 106A, as shown in 1425. The response message can include any information from the other wireless device (2) 106B . . . N that may be necessary to establish a Wi-Fi link with the first wireless device 106A. For example, encryption keys may be exchanged.

The Wi-Fi information in operation 1420 may be communicated in the payload section of the Bluetooth header, such as the example Bluetooth header in the PDU 1000 or another type of desired Bluetooth header. In one example, the Wi-Fi information can be included in a new packet encapsulation type for Bluetooth that will carry WLAN data via a header bit. Upon receiving the packet, a BT device can detect, using the header bit, that the packet is intended for critical Wi-Fi operation and thus needs to be passed to Wi-Fi application layers.

In one example, the Wi-Fi information can be communicated from the Wi-Fi logic 332 to the Bluetooth logic 336, as shown in FIG. 3. The Wi-Fi connection information may be communicated to the application layer in the Bluetooth protocol stack 550. An application processor 302 and/or a baseband processor in the wireless communication circuitry 230 can prepare the Wi-Fi connection information for transmission from the first wireless device 106A to the other wireless device(s) 106B . . . N.

In some embodiments, the Wi-Fi information may be communicated from any of the layers in the IEEE 802 reference model 1200 (FIG. 12) or the Wi-Fi host comprising the upper layer protocols connected through the LSAP, to any of the layers in a Bluetooth protocol stack, such as the Bluetooth protocol stack 550 (FIG. 5B), for transmission using the Bluetooth protocols to provide a desired reduction in latency. The Wi-Fi information may be communicated using one or more packets in one or more slots, as shown in FIGS. 6 and 8. The first wireless device 106A and other wireless device(s) 106B . . . N can use AFH to find open channels that can be used to communicate the Wi-Fi connection information when there is interference and/or in a relatively noisy environment. In one embodiment, the Wi-Fi connection information can be communicated in one connection interval, as shown in FIG. 6. Alternatively, multiple connection intervals may be used to transmit multiple packets in good channels. While Bluetooth Versions 1.0 to 6.0 are currently used for communication in the 2.4 GHz ISM band, this is not intended to be limiting for this application. Other frequency bands in the ISM or Wi-Fi bands may also be used for Bluetooth communication. The Wi-Fi connection information can be used to establish the Wi-Fi connection at any of the Wi-Fi frequency bands or channels, such as the bands and channels listed in the Wi-Fi specifications.

The first wireless device 106A can establish a Wi-Fi connection with the other wireless device(s) 106B . . . N, as shown in 1430. The Wi-Fi connection can be established based on the Wi-Fi information obtained via the Bluetooth Connection in operation 1420, and optionally in 1425.

In some embodiments, the first wireless device 106A and the other wireless device(s) 106B . . . N can communicate using the Wi-Fi connection, as shown in 1440. In some embodiments, the Wi-Fi connection can be used the same as if the Wi-Fi connection had previously been established using standard Wi-Fi connection protocols. The first wireless device 106A and the other wireless device(s) 106B . . . N can then communicate on using the Wi-Fi connection. This can enable the first wireless device 106A and the other wireless devices 106B . . . N to establish a connection using a relatively low latency Bluetooth communication channel, and then perform communication over one or more Wi-Fi channels to provide broadband communication between the wireless devices 106A . . . N. Accordingly, the use of both Bluetooth specification based communication and Wi-Fi specification based communication can provide a low latency (e.g. less than 1 ms or less than 5 ms) connection interval using Bluetooth signaling to establish a Wi-Fi connection, and broadband communication between the first wireless device 106A and the other wireless devices 106B . . . N.

In an alternative embodiment, the Bluetooth connection can also be used to communicate Wi-Fi information, such as data that would typically be communicated using Wi-Fi, as shown in 1450. The Wi-Fi information can be communicated from any of the layers in the IEEE 802 reference model 1200 (FIG. 12) or upper layer protocols connected through the LSAP, to any of the layers in a Bluetooth protocol stack, such as the Bluetooth protocol stack 550 (FIG. 5B), for transmission using the Bluetooth protocols, as previously discussed. The Wi-Fi data can be communicated via the Bluetooth connection for a selected period of time. In one example, the Wi-Fi data can be communicated via the Bluetooth connection when a noise or interference in the Wi-Fi connection is greater than a selected threshold. In another example, the Wi-fi data can be communicated via the Bluetooth connection to provide a lower latency connection for a selected period of time.

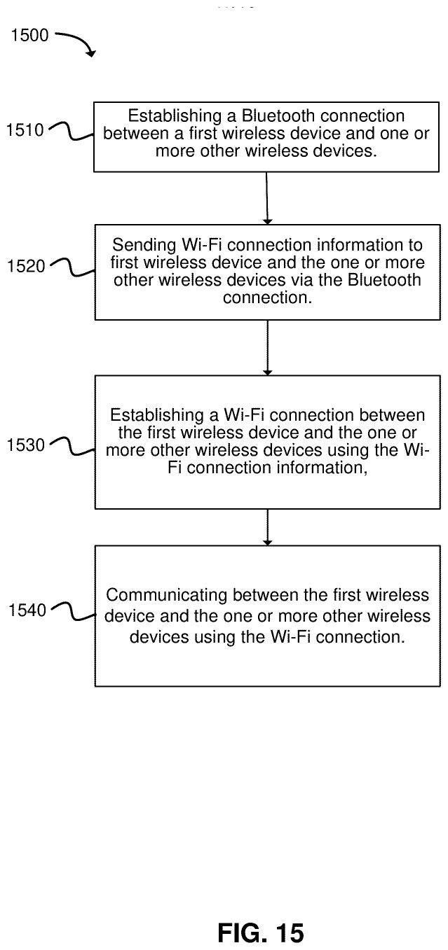

FIG. 15: Method of establishing a Wi-Fi connection at a first wireless device using Bluetooth.

FIG. 15 illustrates an example flow chart of a method 1500 of establishing a Wi-Fi connection at a first wireless device using Bluetooth, according to some embodiments.

The method shown in FIG. 15 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, the method 1500, comprises establishing a Bluetooth connection between a first wireless device and one or more other wireless devices, as shown in 1510. Wi-Fi connection information is sent from the first wireless device to the one or more other wireless devices via the Bluetooth connection, as shown in 1520. A Wi-Fi connection between the first wireless device and the one or more other wireless devices is established using the Wi-Fi connection information, as shown in 1530. The first wireless device and the one or more other wireless devices communicate using the Wi-Fi connection, as shown in 1540.

In some embodiments, the Wi-Fi connection information is encapsulated in a Bluetooth packet that includes one or more header bits identifying the Bluetooth packet as containing Wi-Fi connection information, such that the Wi-Fi connection information can be communicated to wireless communication circuitry including Wi-Fi logic for establishing the Wi-Fi connection. In one example, the Bluetooth packet is communicated at an application layer of Bluetooth logic to an application layer of Wi-Fi logic.

In some embodiments, the first wireless device is a primary wireless device configured to broadcast the Wi-Fi connection information to the one or more other wireless devices via the Bluetooth connection. Alternatively, the first wireless device can be configured to transmit the Wi-Fi connection information in a Bluetooth unicast to a single wireless device of the one or more other wireless devices.

In some embodiments, the Wi-Fi connection information comprises information included in a Wi-Fi medium access control (MAC) header and includes information in one or more of a control frame, a management frame, or a data frame.

In some embodiments, the method 1500 further comprises receiving, via the Bluetooth connection, response information for establishing the Wi-Fi connection between the first wireless device and the one or more other wireless devices.

In some embodiments, the response information is encapsulated in a Bluetooth packet that comprises one or more header bits identifying the Bluetooth packet as containing the Wi-Fi connection information.

In some embodiments, the Bluetooth packet is received in a payload section of a Bluetooth packet in the Bluetooth connection between the first wireless device and the one or more other wireless devices.

In some embodiments, the Bluetooth packet containing the Wi-Fi connection information is communicated to one or more layers in an Institute of Electronics and Electrical Engineers (IEEE) 802 protocol stack or one or more upper layer protocols connected to the IEEE 802 protocol stack via a logical link control (LLC) layer service access point (LSAP).

In some embodiments, the method 1500 further comprises sending the Wi-Fi connection information from the first wireless device to the one or more other wireless devices via the Bluetooth connection in one or more protocol data units (PDUs) in a connection interval.

In some embodiments, the method 1500 further comprises encoding the Wi-Fi connection information for transmission on the Bluetooth connection using a baseband processor of the first wireless device.

In some embodiments, an apparatus is disclosed configured to cause the first wireless device, having one or more processors coupled to a memory, to perform any of the embodiments of the method 1500.

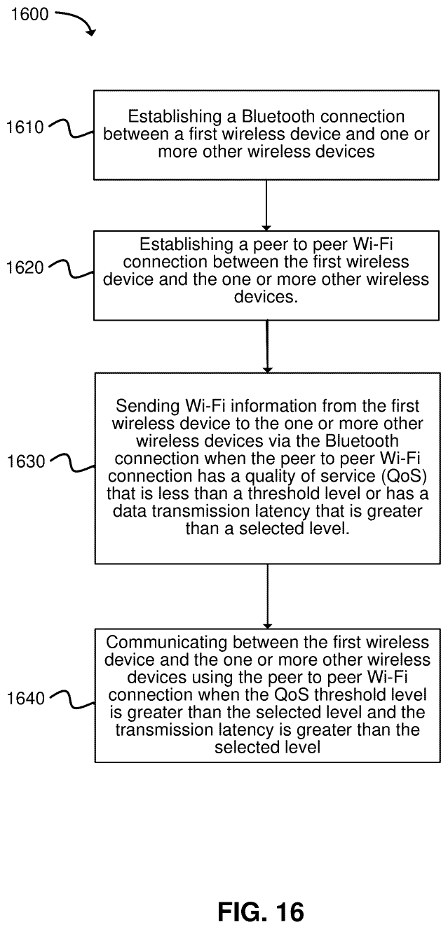

### FIG. 16: Method of Sending Wi-Fi Information Using Bluetooth

FIG. 16 illustrates an example flow chart of a method 1600 of sending Wi-Fi information using Bluetooth, according to some embodiments.

The method shown in FIG. 16 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, the method 1600, comprises establishing a Bluetooth connection between a first wireless device and one or more other wireless devices, as shown in 1610. A peer to peer Wi-Fi connection is established between the first wireless device and the one or more other wireless devices, as shown in 1620.

The method 1600 further comprises sending Wi-Fi information from the first wireless device to the one or more other wireless devices via the Bluetooth connection when the peer to peer Wi-Fi connection has a quality of service (QoS) that is less than a threshold level or has a data transmission latency that is greater than a selected level, as shown in 1630.

The method 1600 further comprises communicating between the first wireless device and the one or more other wireless devices using the peer to peer Wi-Fi connection when the QoS threshold level is greater than the selected level or the transmission latency is greater than the selected level, as shown in 1640.

In some embodiments, the Wi-Fi information is encapsulated in a Bluetooth packet that includes one or more header bits identifying the Bluetooth packet as containing Wi-Fi information to enable the one or more other wireless devices to identify the Bluetooth packet as containing Wi-Fi information and communicate the Wi-Fi information to wireless communication circuitry including Wi-Fi logic.

In some embodiments, the first wireless device is a primary wireless device configured to broadcast the Wi-Fi information to the one or more other wireless devices via the Bluetooth connection.

In some embodiments, the Bluetooth packet is communicated at an application layer of Bluetooth logic to an application layer of Wi-Fi logic.

In some embodiments, the method 1600 further comprises sending the Wi-Fi connection information from the first wireless device to the one or more other wireless devices via the Bluetooth connection in one or more protocol data units (PDUs) in a connection interval.

In some embodiments, the method further comprises encoding the Wi-Fi connection information for transmission on the Bluetooth connection using a baseband processor of the first wireless device.

In some embodiments, a computer program product is disclosed that comprises computer instructions which, when executed by one or more processors, perform any of the operations described herein.

In some embodiments, an apparatus is configured to cause the first wireless device, having one or more processors coupled to a memory, to perform any of the embodiments of the method 1600.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of establishing a Wi-Fi connection at a first wireless device using Bluetooth, comprising:
establishing a Bluetooth connection between a first wireless device and one or more other wireless devices;
sending Wi-Fi connection information from the first wireless device to the one or more other wireless devices via the Bluetooth connection;
establishing a Wi-Fi connection between the first wireless device and the one or more other wireless devices using the Wi-Fi connection information; and
communicating between the first wireless device and the one or more other wireless devices using the Wi-Fi connection.

2. The method of claim 1, wherein the Wi-Fi connection information is encapsulated in a Bluetooth packet that includes one or more header bits identifying the Bluetooth packet as containing Wi-Fi connection information, such that the Wi-Fi connection information can be communicated to wireless communication circuitry including Wi-Fi logic for establishing the Wi-Fi connection.

3. The method of claim 1, wherein the first wireless device is a primary wireless device configured to broadcast the Wi-Fi connection information to the one or more other wireless devices via the Bluetooth connection.

4. The method of claim 1, wherein the first wireless device is configured to transmit the Wi-Fi connection information in a Bluetooth unicast to a single wireless device of the one or more other wireless devices.

5. The method of claim 2, wherein the Bluetooth packet is communicated at an application layer of Bluetooth logic to an application layer of Wi-Fi logic.

6. The method of claim 1, wherein the Wi-Fi connection information comprises information included in a Wi-Fi medium access control (MAC) header and includes information in one or more of a control frame, a management frame, or a data frame.

7. The method of claim 1, further comprising receiving, via the Bluetooth connection, response information for establishing the Wi-Fi connection between the first wireless device and the one or more other wireless devices.

8. The method of claim 7, wherein the response information is encapsulated in a Bluetooth packet that comprises one or more header bits identifying the Bluetooth packet as containing the Wi-Fi connection information.

9. The method of claim 8, wherein the Bluetooth packet is received in a payload section of a Bluetooth packet in the Bluetooth connection between the first wireless device and the one or more other wireless devices.

10. The method of claim 8, wherein the Bluetooth packet containing the Wi-Fi connection information is communicated to one or more layers in an Institute of Electronics and Electrical Engineers (IEEE) 802 protocol stack or one or more upper layer protocols connected to the IEEE 802 protocol stack via a logical link control (LLC) layer service access point (LSAP).

11. The method of claim 1, further comprising sending the Wi-Fi connection information from the first wireless device to the one or more other wireless devices via the Bluetooth connection in one or more protocol data units (PDUs) in a connection interval.

12. The method of claim 1, further comprising encoding the Wi-Fi connection information for transmission on the Bluetooth connection using a baseband processor of the first wireless device.

13. An apparatus configured to cause the first wireless device, having one or more processors coupled to a memory, to perform the method of claim 1.

14. A method of sending Wi-Fi information using Bluetooth, comprising:
establishing a Bluetooth connection between a first wireless device and one or more other wireless devices;
establishing a peer to peer Wi-Fi connection between the first wireless device and the one or more other wireless devices;
sending the Wi-Fi information from the first wireless device to the one or more other wireless devices via the Bluetooth connection when the peer to peer Wi-Fi connection has a quality of service (QoS) that is less than a threshold level or has a data transmission latency that is greater than a selected level; and
communicating between the first wireless device and the one or more other wireless devices using the peer to peer Wi-Fi connection when the QoS threshold level is greater than the selected level or the transmission latency is greater than the selected level.

15. The method of claim 14, wherein the Wi-Fi information is encapsulated in a Bluetooth packet that includes one or more header bits identifying the Bluetooth packet as containing the Wi-Fi information to enable the one or more other wireless devices to identify the Bluetooth packet as containing the Wi-Fi information and communicate the Wi-Fi information to wireless communication circuitry including Wi-Fi logic.

16. The method of claim 15, wherein the first wireless device is a primary wireless device configured to broadcast the Wi-Fi information to the one or more other wireless devices via the Bluetooth connection.

17. The method of claim 16, wherein the Bluetooth packet is communicated at an application layer of Bluetooth logic to an application layer of Wi-Fi logic.

18. The method of claim 15, further comprising sending the Wi-Fi information from the first wireless device to the one or more other wireless devices via the Bluetooth connection in one or more protocol data units (PDUs) in a connection interval.

19. The method of claim 15, further comprising encoding the Wi-Fi information for transmission on the Bluetooth connection using a baseband processor of the first wireless device.

20. An apparatus configured to cause the first wireless device, having one or more processors coupled to a memory, to perform the method of claim 14.
